(19) United States
(12) Patent Application Publication
(10) Pub. No.: US 2002/0142202 A1
(43) Pub. Date: Oct. 3, 2002

(54) Fibrous electrode for a metal air electrochemical cell

(76) Inventors: Lin-Feng Li, Croton, NY (US); Mark Stevens, Metuchen, NJ (US); Tsepin Tsai, Chappaqua, NY (US); Rene Lemieux, Poughkeepsie, NY (US)

Correspondence Address: Evionyx, Inc., 85 Executive Blvd., Elmsford, NY, 10523, US

(21) Appl. No.: 10/083,717

(22) Filed: Feb. 25, 2002

Related U.S. Application Data
(60) Provisional application No. 60/270,952, filed on Feb. 23, 2001.
(60) Provisional application No. 60/270,816, filed on Feb. 23, 2001.

(51) Int. Cl. H01M 4/42; H01M 4/86; H01M 4/38; H01M 4/40; H01M 4/62; H01M 4/44; H01M 4/46

(52) U.S. Cl. 429/27; 429/40; 429/218.1; 429/229; 429/231.6; 429/231.95; 429/221; 429/232; 429/217

(57) ABSTRACT

An electrode for an electrochemical cell is provided. The electrode comprises a plurality of fibers comprised of an electrically conductive material configured to conduct electrons to an electrolyte of the electrochemical cell.

### RELATED APPLICATIONS

This application claims priority to U.S. Provisional Application Ser. Nos. 60/270,952 entitled “FIBROUS ELECTRODE FOR A METAL AIR ELECTROCHEMICAL CELL” filed on Feb. 23, 2001 and 60/270,816 entitled “METHOD OF MANUFACTURE FOR A FIBROUS ELECTRODE FOR A METAL AIR ELECTROCHEMICAL CELL” filed on Feb. 23, 2001, both of which are incorporated herein by reference.

### BACKGROUND OF THE INVENTION

1. Field of the Invention

This invention relates to electrodes formed of metal fibers or filaments, and particularly to fibrous metallic electrodes for metal air cells.

2. Description of the Prior Art

Electrochemical energy enables direct generation of electricity from chemical compositions. This type of energy generation allows for relatively high energy density on a weight basis with relatively high current densities. Examples of devices based on the electrochemical energy include electrochemical cells configured as battery cells, fuel cells, or fuel cell batteries (FCB).

A storage battery is a voltaic battery constructed of storage cells. Each cell contains plates referred to as positive (anode) and negative (cathode) electrodes contained in an electrolyte, typically a liquid electrolyte. When a charged storage battery cell is discharged through a load, the plates and the electrolyte undergo a chemical change wherein the negative cathode loses electrons and the positive anode gains electrons thereby providing a current flow. During charging operations, applying a current flow that is opposite to that produced during the discharge generally restores the original conditions of the battery.

Conventional batteries employ cells formed of lead-acid, nickel-cadmium, and nickel-metal hydrides. These conventional battery technologies based on lead acid, nickel-cadmium, or nickel-metal hydrides have limited operation time, long recharge time, low energy density, hazardous chemical materials requiring special encapsulation containers and careful disposal, and fixed electrode areas. Nickel-metal hydride batteries, while eliminating cadmium, a very toxic substance, generally deliver less power, have a faster self-discharge rate, and are less tolerant of overcharging as compared to conventional cells.

Another type of battery system, a lithium-polymer battery, employs a lithium anode, a polymer electrolyte and a composite cathode such as LiCoO₂. However, the high reactivity of lithium with liquid electrolytes erodes the electrodes of such battery cells. While recent developments in solid state electrolytes have reduced this problem, dendrite formation of the electrode materials still remains a problem.

Battery development is also evolving with other metals, such as zinc, in combination with air. Metal-air battery technology conventionally includes electrodes having fixed areas, however, metal-air batteries using variable area electrodes have also been contemplated. Variable area electrode systems (for example, capable of being used with metal-air batteries) are disclosed in U.S. Pat. No. 5,250,370 to Sadeg M. Faris, which is herein incorporated by reference.

Fuel cells are generally electrochemical cells that convert chemical energy of the fuel directly into usable electricity without combustion of the fuel. Conventional electrochemical reactions are generally not reversible (i.e., rechargeable). Fuel cells are similar to battery cells in that both produce a DC current by using an electrochemical process. Both fuel cells and battery cells have positive and negative electrodes (i.e. the anodes and cathodes) and an ionic conductor or electrolyte. The primary difference between fuel cells and battery cells is that battery cells have only a limited amount of stored energy, whereas fuel cells will continue to produce electrical power output as long as fuel and oxidant are supplied thereto.

Conventional fuel cells operate by combining hydrogen with oxygen to release electricity (i.e. charge), heat, and water. The supply of fuel can be pure hydrogen, or hydrogen extracted from natural gas or other hydrocarbons with a reformer. Presently, several different conventional fuel cell technologies are being considered by the power industry for power generation, including phosphoric acid fuel cells (PAFCs); molten carbonate fuel cells (MCFCs); solid oxide fuel cells (SOFCs); and solid polymer fuel cells (SPFCs). These different fuel cell technologies differ in terms of the composition of the electrolyte used. These conventional hydrogen-oxygen fuel cells suffer from a number of shortcomings and drawbacks that have restricted their widespread usage. In particular, prior art hydrogen-oxygen fuel cells require operation at either high pressure and/or temperature. The hydrogen-oxygen fuel poses risk of explosion and requires careful handling and distribution. These fuel cells require a co-generation application for the heat produced in order to reach high efficiency levels.

A particularly desirable fuel cell technology includes metal fuel used in a metal air fuel cell. Typically, a plurality of fuel cells, each of which generate a relatively low voltage, are electrically connected to form a fuel cell battery capable of generating a desired voltage. A metal air fuel cell battery is disclosed in U.S. Pat. No. 3,432,354 to Jost. As disclosed therein, the anode is moved past the stationary cathode during discharge and charging operations. In illustrative embodiments, the anode is based on metals such as zinc, aluminum, and other alloys. The anode material is arranged as a roll of thin zinc foil wound on a supply roller. As the fuel moves past a discharge cathode, and is taken up on a take-up roller in the presence of an electrolyte, electrical power is produced across the anode and cathode and removed by an electrical load connected thereto.

Other metal air fuel cell batteries use metal fuel cards, tapes, and fluids in various configurations. Examples of some of these fuel cell batteries are disclosed in commonly assigned: U.S. Pat. No. 6,296,960 entitled “System And Method For Producing Electrical Power Using Metal Air Fuel Cell Battery Technology” by Sadeg M. Faris, Yuen-Ming Chang, Tsepin Tsai, and Wayne Yao, issued on Oct. 2, 2001; U.S. Pat. No. 6,228,519 entitled “Metal-Air Fuel Cell Battery Systems Having Mechanism For Extending The Path Length Of Metal-Fuel Tape During Discharging And Recharging Modes Of Operation” by Sadeg M. Faris and Tsepin Tsai, issued on May 8, 2001; U.S. patent application Ser. Nos. 09/110,761 and 09/133,166, both entitled “Metal-Air Fuel Cell Battery System Employing A Plurality Of Moving Cathode Structures For Improved Volumetric Power Density” by Sadeg M. Faris, Tsepin Tsai, Thomas J. Legbandt, Wayne Yao, and Muguo Chen, filed on Jul. 3, 1998 and Aug. 12, 1998, respectively, which are both fully incorporated by reference herein; U.S. patent application Ser. No. 09/074,337 entitled “Metal-Air Fuel Cell Battery Systems” by Sadeg M. Faris and Tsepin Tsai, filed on May 7, 1998; U.S. Pat. No. 6,299,997 entitled “Metal-Air Fuel Cell Battery System Employing Metal Fuel Tape And Low-Friction Cathode Structures” by Sadeg M. Faris, Tsepin Tsai, Thomas J. Legbandt, Muguo Chen, and Wayne Yao, issued on Oct. 9, 2001; U.S. Patent Number entitled “Metal-Air Fuel Cell Battery System Having Means For Controlling Discharging And Recharging Parameters For Improved Operating Efficiency” by Sadeg M. Faris and Tsepin Tsai, issued on Sep. 11, 2001; U.S. patent application Ser. No. 09/130,325 entitled “Metal-Air Fuel Cell Battery System Having Means For Recording and Reading Operating Parameters During Discharging And Recharging Modes Of Operation” by Sadeg M. Faris and Tsepin Tsai, filed on Aug. 6, 1998; U.S. patent application Ser. No. 09/116,643 entitled “Metal-Air Fuel Cell Battery System Employing Means For Discharging And Recharging Metal Fuel Cards” by Sadeg M. Faris, Tsepin Tsai, Wenbin Yao, and Muguo Chang, filed on Jul. 16, 1998; U.S. patent application Ser. No. 09/120,583 entitled “Metal-Air Fuel Cell Battery System Having Means For Bi-Directionally Transporting Metal-Fuel Tape and Managing Metal-Fuel Available Therealong” by Sadeg M. Faris, filed on Jul. 22, 1998; U.S. Pat. No. 6,239,508 entitled “Metal-Air Fuel Cell Battery System Having Means For Managing The Discharging And Recharging Of Metal Fuel Contained Within A Network Of Metal-Air Fuel Cell Battery Subsystems” by Sadeg M. Faris and Tsepin Tsai, issued on May 29, 2001; U.S. Pat. No. 6,312,844 entitled “Metal-Air Fuel Cell Battery System Having Means For Discharging And Recharging Metal-Fuel Cards Supplied From a Cassette-Type Storage Device” by Sadeg M. Faris, issued on Nov. 6, 2001; U.S. Pat. No. 6,299,998 entitled “Movable Anode Fuel Cell Battery” by Tsepin Tsai and William Morris, issued on Oct. 9, 2001; U.S. patent application Ser. No. 09/631,606 entitled “Metal-Air Fuel Cell Battery Device And System With Selectively Activatable Cathode And Anode Elements” by Sadeg M. Faris and Tsepin Tsai, filed on Aug. 3, 2000; U.S. patent application Ser. No. 09/632,329 entitled “Fuel Cell With Multiple Cell Arrays Of Different Types” by Sadeg M. Faris and Tsepin Tsai, filed on Aug. 3, 2000; U.S. patent application Ser. No. 09/632,331 entitled “Metal-Air Fuel Cell Battery System With Multiple Cells And Integrated Apparatus For Producing Power Signals With Stepped-Up Voltage Levels By Selectively Discharging The Multiple Cells” by Sadeg M. Faris and Tsepin Tsai, filed on Aug. 3, 2000; U.S. patent application Ser. No. 09/414,874 entitled “Electro-Chemical Power Generation Systems Employing Arrays Of Electronically-Controllable Discharging And/Or Recharging Cells Within A Unity Support Structure” by Sadeg M. Faris and Tsepin Tsai, filed on Oct. 8, 1999; U.S. patent application Ser. No. 09/695,697 entitled “Appliance With Refuelable And Rechargeable Metal-Air Fuel Cell Battery Power Supply Unit Integrated Therein” by Sadeg M. Faris and Tsepin Tsai, filed on Oct. 24, 2000; U.S. patent application Ser. No. 09/695,699 entitled “Power Generation and Distribution System/Network Having Interruptable Power Source And Refuelable And Rechargeable Metal-Air Fuel Cell Battery Subsystem” by Sadeg M. Faris and Tsepin Tsai, filed on Oct. 24, 2000; and U.S. patent application Ser. No. 09/695,698 entitled “Refuelable And Rechargeable Metal-Air Fuel Cell Battery Power Supply Unit For Integration Into An Appliance” by Sadeg M. Faris and Tsepin Tsai, filed on Oct. 24, 2000; wherein each of these commonly assigned applications are fully incorporated by reference herein in their entireties.

Metal air fuel cell batteries have numerous advantages over traditional hydrogen-based fuel cells. In particular, the supply of energy provided from metal air fuel cell batteries is virtually inexhaustible because the fuel, such as zinc, is plentiful and can exist either as the metal or its oxide. Further, solar, hydroelectric, or other forms of energy can be used to convert the metal from its oxide product back to the metallic fuel form. Unlike conventional hydrogen-oxygen fuel cells that require refilling, the fuel of metal air fuel cell batteries is recoverable by electrically recharging. The fuel of the metal air fuel cell batteries is solid state, therefore, it is safe and easy to handle and store. In contrast to hydrogen-oxygen fuel cell batteries, which use methane, natural gas, or liquefied natural gas to provide as source of hydrogen, and emit polluting gases, the metal air fuel cell batteries results in zero emission. The metal air fuel cell batteries operate at ambient temperature, whereas hydrogen-oxygen fuel cells typically operate at temperatures in the range of 150° C. to 1000° C. Metal air fuel cell batteries are capable of delivering higher output voltages (1.5-3 Volts) than conventional fuel cells (<0.8 V).

One of the principle obstacles of metal air fuel cell batteries, primarily in variable demand uses such as automotive vehicle propulsion, is the difficulty in maintaining a high continuous current drain along with short term high peak power output, while maintaining high energy density and facilitating rapid rechargeability.

U.S. Pat. No. 3,871,918 to Viescou discloses an electrochemical cell embodying an electrode of zinc powder granules suspended in an electrolyte gel. Other zinc anodes are formed from powdered zinc which is sintered or wetted and pressed into a plate. Additionally, as disclosed in U.S. Pat. No. 4,842,963 to Ross, zinc may be electroplated on a current collector, or zinc oxide and a plastic binder paste may be applied and electroformed on a current collector. Further, U.S. Pat. No. 5,599,637 to Pecherer et al. discloses a zinc anode including a skeletal frame with a composition consisting of zinc and an electrolyte formed thereon.

These anodes suffer drawbacks in use, particularly related to the depth of discharge of metal air fuel cells or fuel cell batteries, shock resistance of the anode, and volume expansion of the metal. Conventionally, the metallic granules are the electron conductors. To achieve peak power, high granule density is desired. However, high granule density negatively effects the porosity of the anode, thus the current capacity is diminished.

Additionally, conventional electrodes for metal air cells formed of granules are not resistant to shock. Such electrodes tend to crumble into clumps or the original granule form when exposed to physical or mechanical shock. This substantially increases manufacturing and handling costs, as well as limits the ability to provide refuelable metal air electrochemical cells.

Further, volume expansion of the metal is a known problem. Electrode shape change generally involves migration of zinc from the certain regions of the electrode to other reasons, and occurs, in part, as the active electrode material dissolves away during battery discharge. Swelling and deformity of zinc electrodes also occur due to the differences in volume of metallic zinc and its oxidation products zinc oxide and zinc hydroxide. Electrode shape distorts as the zinc is redeposited in a dense solid layer, thereby minimizing available active electrode material and preventing electrolyte access to the electrode interior.

Thus there is a great need in the art for an improved electrode, particularly a metal anode, for metal-air batteries, fuel cells, and fuel cell batteries.

### SUMMARY OF THE INVENTION

The above-discussed and other problems and deficiencies of the prior art are overcome or alleviated by the several methods and apparatus of the present invention, wherein an electrode for an electrochemical cell is provided. The electrode comprises a plurality of fibers comprised of an electrically conductive material configured to conduct electrons to an electrolyte of the electrochemical cell. The electrically conductive material may be selected from the group consisting of zinc, aluminum, magnesium, cadmium, lithium, ferrous metals, and combinations and alloys comprising at least one of the foregoing materials. Materials such as bismuth, aluminum, indium, lead, mercury, gallium, and the like may be used in certain alloys.

The above-discussed and other features and advantages of the present invention will be appreciated and understood by those skilled in the art from the following detailed description and drawings.

### BRIEF DESCRIPTION OF THE DRAWINGS

Numerous other advantages and features of the present invention will become readily apparent from the following detailed description of preferred embodiments when read in conjunction with the accompanying drawings, wherein:

FIG. 1 is a schematic representation of a metal-air fuel cell;

FIG. 2 is a schematic view of a fibrous electrode;

FIG. 3 is a detailed view of a portion of a metal electrode according to an embodiment herein;

FIG. 4 is a detailed view of a portion of a conventional zinc electrode;

FIG. 5 is a schematic of a manufacturing process for the metal electrode;

FIG. 6 shows a configuration of a fibrous metal electrode formed in part according to the technique described with respect to FIG. 5;

FIG. 7 is a schematic view of an alternative configuration of a fibrous metal electrode;

FIG. 8 shows the electrode in the configuration of FIG. 7 in assembled state; and

FIG. 9 shows an electrochemical cell employing the electrode of FIGS. 7 and 8.

### DETAILED DESCRIPTION OF THE ILLUSTRATIVE EMBODIMENTS

A metal fuel electrode for batteries, fuel cells, and fuel cell batteries is disclosed comprising metal fibers or filaments. The electrode provides increased depth of discharge of the cell, increased structural stability, increased shock resistance, and minimization of electrode bulging.

Referring now to the drawings, an illustrative embodiment of the present invention will be described. For clarity of the description, like features shown in the figures shall be indicated with like reference numerals and similar features as shown in alternative embodiments shall be indicated with similar reference numerals.

Referring now to FIG. 1, a typical metal air electrochemical cell 10 incorporates a metal anode 12 and an air cathode 14 having a separator 16 disposed therebetween. The shape of the cell and the components therein such as the anode is not constrained to be square or rectangular. It can be circular, elliptical, polygonal, or any desired shape.

An electrolyte is further provided in the system as the source of an ionic species. The electrolyte (either within any one of the variations of the separator herein, or as a liquid within the cell structure in general) generally comprises ion conducting material to allow ionic conduction between the metal anode and the cathode. The electrolyte generally comprises hydroxide-conducting materials such as KOH, NaOH, LiOH, RbOH, CsOH or a combination comprising at least one of the foregoing electrolyte media. In preferred embodiments, the hydroxide-conducting material comprises KOH. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 40% ionic conducting materials.

The separator 16 generally prevents diffusion of zinc oxidation product into the electrolyte solution phase, prevents corrosion of the zinc anode by either the electrolyte solution or air, and prevents blockage of the cathode air channels by water from the electrolyte solution. Separator 16 may be any commercially available separator capable of electrically isolating the anode 12 and the cathode 14, while allowing sufficient ionic transport between the anode 12 and the cathode 14. Preferably, the separator 16 is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator 16 may also comprise additives and/or coatings such as acrylic compounds and the like to make them more wettable and permeable to the electrolyte.

Further, as mentioned above, separator 16 may optionally comprise electrolyte materials including polymer-based solid gel membranes; aqueous electrolytes; or any combination comprising at least one of the foregoing electrolyte materials. Exemplary electrolytes are disclosed in copending, commonly assigned: U.S. patent application Ser. No. 09/156,135, entitled “Polymer-based Hydroxide Conducting Membranes”, to Wayne Yao, Tsepin Tsai, Yuen-Ming Chang, and Muguo Chen, filed Sep. 17, 1998; U.S. patent application Ser. No. 09/259,068, entitled “Solid Gel Membrane”, by Muguo Chen, Tsepin Tsai, Wayne Yao, Yuen-Ming Chang, Lin-Feng Li, and Tom Karen, filed on Feb. 26, 1999; U.S. patent application Ser. No. 09/482,126 entitled “Solid Gel Membrane Separator in Rechargeable Electrochemical Cells”, by Muguo Chen, Tsepin Tsai and Lin-Feng Li, filed Jan. 11, 2000; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties.

The cathode 14 generally includes an active constituent and a carbon material, along with suitable connecting structures, such as a current collector. The cathode portions 40 may optionally comprise a protective layer (e.g., polytetrafluoroethylene commercially available under the trade name Teflon® from E. I. du Pont Nemours and Company Corp., Wilmington, Del.). Generally, the cathode catalyst is selected to attain current densities (in ambient air) of at least 20 milliamperes per squared centimeter (mA/cm²), preferably at least 50 mA/cm², and more preferably at least 100 mA/cm². Higher current densities may be attained with suitable cathode catalysts and formulations and with use of higher oxygen concentrations, such as substantially pure air.

The oxygen supplied to the cathode 14 may be from any oxygen source, such as air; scrubbed air; pure or substantially oxygen, such as from a utility or system supply or from on site oxygen manufacture; any other processed air; or any combination comprising at least one of the foregoing oxygen sources.

Cathode 14 may be a conventional air diffusion cathode, for example generally comprising an active constituent and a carbon substrate, along with suitable connecting structures, such as a current collector. Typically, the cathode catalyst is selected to attain current densities in ambient air of at least 20 milliamperes per squared centimeter (mA/cm2), preferably at least 50 mA/cm2, and more preferably at least 100 mA/cm2. Of course, higher current densities may be attained with suitable cathode catalysts and formulations. The cathode may be a bi-functional, for example, which is capable of both operating during discharging and recharging.

The carbon used is preferably be chemically inert to the electrochemical cell environment and may be provided in various forms including, but not limited to, carbon flake, graphite, other high surface area carbon materials, or combinations comprising at least one of the foregoing carbon forms.

The cathode current collector may be any electrically conductive material capable of providing electrical conductivity and preferably chemically stable in alkaline solutions, which optionally is capable of providing support to the cathode portions 10. The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal such as nickel foam metal.

A binder is also typically used in the cathode, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E. I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent is generally a suitable catalyst material to facilitate oxygen reaction at the cathode. The catalyst material is generally provided in an effective amount to facilitate oxygen reaction at the cathode. Suitable catalyst materials include, but are not limited to: manganese, lanthanum, strontium, cobalt, platinum, and combinations and oxides comprising at least one of the foregoing catalyst materials.

An exemplary air cathode is disclosed in copending, commonly assigned U.S. patent application Ser. No. 09/415,449, entitled “Electrochemical Electrode For Fuel Cell”, to Wayne Yao and Tsepin Tsai, filed on Oct. 8, 1999, which is incorporated herein by reference in its entirety. Other air cathodes may instead be used, however, depending on the performance capabilities thereof, as will be obvious to those of skill in the art.

The metal anode 12 comprises materials in fibrous form (we might need to define the fibrous form), and optionally mixed with granular form, including, but not limited to, oxidizable metals such as zinc, tin, cadmium, lithium, magnesium, ferrous metals, aluminum, and the like, and combinations and alloys comprising at least one of the foregoing metals. Materials that also may be included in alloys include bismuth, aluminum, indium, lead, mercury, gallium, and the like. Preferably, the metal anode comprises zinc or combinations and alloys comprising zinc. Effective amounts of alloy material may be used, depending on the desired properties of the electrode. In one embodiment, an effective zinc alloy composition for fibers contains about 150 parts per million (ppm) indium, 100 ppm gallium, 100 ppm aluminum and 500 ppm lead.

In an alternative embodiment, the fiber may be formed of synthetic fibers, cellulose fibers, or graphite fibers upon which a suitable material as detailed above is deposited upon the fiber.

Optionally, a substrate portion is also provided, comprising a mesh, porous plate, metal foam, or other suitable structure to impart electrical conductivity and optionally provide support to the anode 12. The substrate portion may be a current collector formed of electrically conductive materials including, but not limited to, copper, zinc, silver, gold, brass, and the like, and combinations and alloys comprising at least one of the foregoing materials. In certain embodiments, the current collector is selected from the group consisting of brass mesh, copper mesh, silver mesh, and silver-plated steel mesh.

Referring now to FIG. 2, a schematic of an exemplary anode 12 is provided. A plurality of electrode filaments or fibers 30 formed of materials as described above comprise the metal anode 12. The shape and dimensions of the electrode fibers 30 may vary depending on the numerous factors such as the size of the cell system, the required capacity, the requisite mechanical properties, and the like. For example, the shape may be ribbon-shaped, cylindrical, or have another suitable cross-sectional shape such as rectangular, square, triangular, other polygonal, circular, elliptical, etc. Generally, the electrode fibers 30 have an effective diameter from about 1 nanometer (also referred to as nanofiber or nanowire) to about 5 millimeters, and preferably about 1 nanometer to about 1 millimeter. Of course, the larger effective diameters likely serve more utility in the area of high-capacity, large dimensioned electrodes (e.g., having an area greater than about 100 centimeters squared and a thickness greater than several centimeters), while the smaller effective diameters likely serve more utility in the area of low-capacity, micro dimensioned electrodes (e.g., less than about 1 centimeters squared, or even on the order of a few millimeters squared). The “effective diameter” of a given cross-sectional configuration generally refers to the diameter of a circle having an equivalent cross-sectional area as the given cross-sectional configuration. For example, in one preferred embodiment, the cross-sectional shape of the fibers are essentially rectangular having dimensions of about 1.5 thousandths of an inch (about 0.038 millimeters) thick by 12 thousandths of an inch (about 0.3 millimeters), commercially available from Zinc Products Company, a Division of Alltrista Corporation, Greenville, Tenn. This rectangular shape has an effective diameter of about 0.12 mm.

The length of the electrode fiber 30 may also vary greatly depending on various factors. Generally, the length may be about 0.5 millimeters to about 1000 meters, preferably about 2 millimeters to about 10 meters. The intended manufacturing technique and the dimensions of the electrodes affect the choice of fiber lengths. For example, where the fibers are to be dry poured (e.g., into molds) to form electrodes having surface areas of several tens or hundreds of centimeters squared, a relatively uniform distribution of lengths of less than about 2.5 centimeters is preferred. In one preferred embodiment, a relatively uniform distribution of lengths (greater than about 90% by weight of the fiber lengths having the selected size) of about 0.6 to about 0.7 centimeters, commercially available from Zinc Products Company, a Division of Alltrista Corporation, Greenville, Tenn. Alternatively, where the fibers are to be formed into a mass, e.g., similar to steel wool, and pressed, longer (e.g., on the order of several centimeters, hundreds of centimeters, or even meters) may be desired.

The electrode fibers 30 may be formed by methods including, but not limited to, a metallurgical extrusion method (melt blown method similar to methods used by polymer fiber making industry), mechanical drawing, electrochemical deposition method (as is conventionally known) or a mechanical method using a mill to cut through a metal ingot to generate the fiber.

For example, metal fiber may be created using a typical milling bit used in a milling machine in a direct mechanical method. A metal block is loaded on a milling machine and the milling bit will cut the metal block to create ribbons of material. Therefore, material may be selected for the metal block to suit the needs of the fiber electrode. If the metal block is alloy, the fiber is also an alloy. With proper selection of the tool bit, the shape of the fiber will be different. By using different cutting speed and depth, the fiber dimensions will also be different. The fiber length can be determined by the thickness of the cutting bit, control of the cutting process, and the block dimensions.

These fibers may be formed from a zinc or zinc alloy block, for example, to create zinc fiber for use in electrochemical cells. Long zinc fibers may optimize current collection to achieve high depth of discharge. In addition, the cutting bit can be designed to create special format of the metal fibers to different application.

Another method to form the fibers includes a melt blown method, for example as illustrated in U.S. Pat. No. 5,667,749, or a rotary spin method (as used in the fiber glass making process referenced in Batteries Digest Newsletter, Issue 41, 1999, pp. 13). For example, any of the above materials may be used. Preferably, the material is a zinc alloy fiber, wherein zinc alloy may comprise bismuth, indium, aluminum or cadmium and zinc. The zinc alloy will be melt, and subsequently the fiber will be generated through a die configured with suitable nozzles. Diameter and length may be controlled by adjusting the spin speed or die nozzle size.

To form electrodes from the metal fiber material, various processing techniques can be used, generally based on pressing systems. Electrodes can be pressed to a desired dimension and density in a mold, roller system, or the like. For example, in a mold based system, fibers, preferably of suitable dimension and size distribution as described above, are poured into a mold. Optionally, the metal fibers surround a current collector. The fibers, optionally including the current collector, may be pressed to a desired thickness, forming an integral electrode.

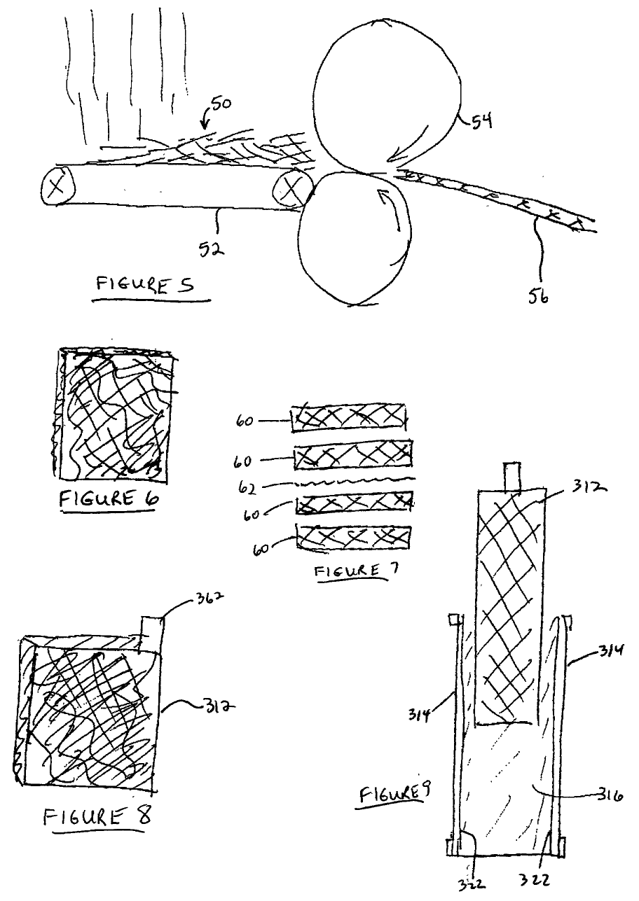

Referring now to FIG. 5, randomly stacked fibers 50 will be transferred to a conveyor belt 52 and then feed into a laminator 54, resulting in a zinc alloy fiber mat 56, which may be substantially similar to anode 12 having fibers 30 as described with respect to FIG. 2. The mat may be cut into a suitable size to form the electrode (FIG. 6). Thickness of the mat may be controlled by the feeding speed of the conveyor. Alternatively, and referring to FIG. 7, several zinc fiber mats 60 can be further laminated together with a substrate 62 such as a mesh current collector. FIG. 8 shows a configuration of an anode 312, having a current collector tab 362 extending therefrom.

Referring to FIG. 9, a metal-air electrochemical cell 310 comprises anode 312, an electrolyte 316, and a pair of cathodes 314. Cathodes 314 are fluidly isolated from electrolyte 316 by separators 322.

Note that modifying the pressure used to form the electrodes may vary the density of the fibrous electrode. Further, air may be intentionally blown into the fibrous material during pressing in order to decrease the density and increase the porosity of the electrode. Such a feature is particularly desirable, for example, when it is desirable to incorporate electrolyte or electrolyte gel in the electrode.

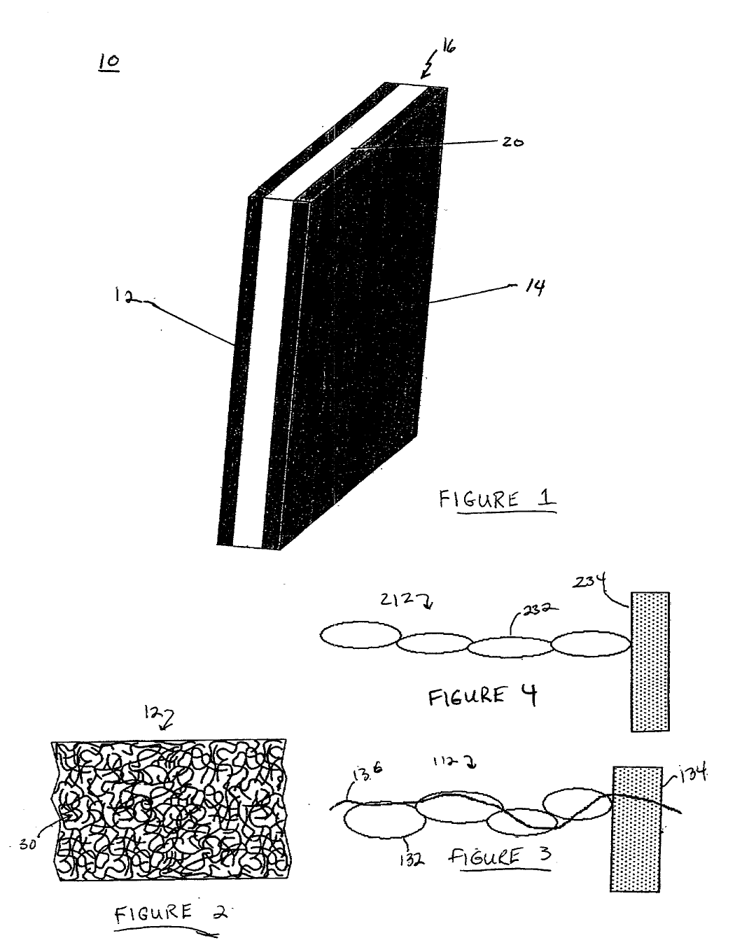

Fibrous electrodes thus made can be used in a zinc-air based fuel cell system. Compared with conventional electrodes, which employ compacted zinc powder with binder materials (see FIG. 4), fiber maintains very good electrical conductivity. For example, a conventional anode 212 comprises a plurality of zinc particles 232 forming a conductive path to a current collector 234. The particle-to-particle contact is relied on as the electric conducting path.

In contrast, in the present electrode, the particle-to-particle contact is not relied on as the electric conducting path, but rather the continuity of the fibers forms the electric conducting path. The porosity or the compacting degree of the electrode comprising plurality of fibers, therefore, can be controlled independently. The porosity may be controlled so that the void volume within the electrode is sufficient to accommodate the volume expansion of the zinc after discharge. In conventional cells, this is a problem that can cause cell bulging.

Further, a fibrous electrode can provide very high surface area by controlling the diameter of the fiber. For example, a zinc alloy fiber anode demonstrated greater than 2 Amperes per squared centimeter in a zinc air battery.

A zinc-air cell with the anode made of such fibrous electrode was further tested with simulated road vibration condition, as compared with a conventional anode. The fibrous electrode was capable of sustaining such vibration without disintegration and the performance maintains the same as without vibration. This is in stark contrast to zinc electrodes formed of granular material, as such electrodes likely would crack or disintegrate. Further, a zinc air cell with the fibrous electrode was discharged, and no bulging was found in the cell.

In another embodiment, and referring now to FIG. 3, fibers 136 and powder granules 132 are mixed to form an anode 112. A current collector 134 is also provided in this example, although an embodiment may be formed without the current collector. In this manner, the structure integrity and electrical conductivity of the anode may be increased.

For a traditional anode made of granule zinc (FIG. 4), electrons generated from the granules 232 far away from the current collector 234 have to travel through several zinc granules 232 and accordingly several granule boundaries before reaching the current collector 234; however, with the help of the fiber 136, the same electron only need to travel through one boundary between a granule 132 and the fiber 136. This efficient electron conducting path becomes more significant once anode reaches a deep discharged state. In order to improve the specific energy of the cell further, the mixed zinc fiber and granule are employed as the starting point of anode formula optimization. Moreover, since the zinc fiber has the structural strength to support itself, the anode made of such a mixture will not settle down over time, which is commonly reported as a problem.

The electrode detailed herein provides various benefits, including: increasing the structural stability of a metal fuel electrode; increasing resistance to the shock impact; increasing the electric conductivity; increasing the surface area of the metal, thereby increasing the current density; providing the ability to control porosity of the electrode without detrimentally effecting conductivity; and minimizing the bulging problem encountered in conventional cells.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. An electrode for an electrochemical cell comprising:
a plurality of fibers comprising an electrically conductive material configured to conduct electrons to an electrolyte of the electrochemical cell.

2. The electrode as in claim 1, wherein the electrically conductive material is selected from the group consisting of zinc, aluminum, magnesium, cadmium, lithium, ferrous metals, and combinations and alloys comprising at least one of the foregoing materials.

3. The electrode as in claim 1, wherein the electrically conductive material comprises zinc alloyed with a metal selected from the group consisting of bismuth, aluminum, indium, lead, mercury, gallium, and combinations and alloys comprising at least one of the foregoing materials.

4. The electrode as in claim 1, wherein the fibers have an effective diameter of about 1 nanometer to about 5 millimeters.

5. The electrode as in claim 1, wherein the fibers have an effective diameter of about 1 nanometer to about 1 millimeter.

6. The electrode as in claim 1, wherein the fibers have an effective diameter of about 0.05 millimeters to about 0.25 millimeters.

7. The electrode as in claim 1, wherein the fibers have an effective diameter of about 0.10 millimeters to about 0.15 millimeters.

8. The electrode as in claim 1, wherein the fibers have a cross-sectional shape selected from the group consisting of rectangular, square, triangular, other polygonal, circular, elliptical, and combinations comprising at least one of the foregoing shapes.

9. The electrode as in claim 1, wherein the fibers have a length of about 0.5 millimeters to about 1000 meters.

10. The electrode as in claim 1, wherein the fibers have a length of about 2 millimeter to about 10 meters.

11. The electrode as in claim 1, wherein the fibers have a length of about 2 millimeters to about 10 millimeters.

12. The electrode as in claim 1, wherein the fibers have a length of about 5 millimeters to about 7.5 millimeters.

13. An electrochemical cell comprising a first electrode, a second electrode, and an electrolyte in ionic contact between the first electrode and the second electrode, wherein the first electrode comprises the electrode as in claim 1.

14. The electrochemical cell as in claim 8, wherein the electrochemical cell is configured as a battery cell, a fuel cell, or a fuel cell battery.

15. The electrode as in claim 1, wherein at least a portion of said fibers comprise a synthetic fiber, a cellulose fiber, or a graphite fiber coated with the electrically conductive material.

16. The electrode as in claim 1 formed by methods selected from the group consisting of metallurgical extrusion methods, mechanical drawing, electrochemical deposition method, and mechanical methods.

17. The electrode as in claim 1, the fibers formed by cutting a block formed of the electrically conductive material.

18. The electrode as in claim 1, formed by melting the electrically conductive material; processing the melted material through a die to form fibers, and conveying the fibers through laminator to form a fiber mat.

19. The electrode as in claim 18, further wherein the fiber mat is laminated with a substrate.

20. The electrode as in claim 1, further comprising a plurality of granules of another electrically conductive material dispersed within the fibers, wherein the granule electrically conductive material may be the same or different from the fiber electrically conductive material.

21. The electrode as in claim 20, wherein the granule electrically conductive material and the fiber electrically conductive material comprise zinc or a zinc alloy.

22. A zinc-air electrochemical cell comprising a first electrode, a second electrode, and an electrolyte in ionic contact between the first electrode and the second electrode, wherein the first electrode comprises the electrode as in claim 1 and further wherein the electrically conductive material comprise zinc or a zinc alloy.
